(19) United States
(12) Patent Application Publication
(10) Pub. No.: US 2013/0114253 A1
(43) Pub. Date: May 9, 2013

(54) Bulb-Type Lamp and Luminaire

(71) Applicants: Masao Segawa, Yokosuka-shi (JP); Nobuo Shibano, Yokosuka-shi (JP); Nobuhiko Betsuda, Yokosuka-shi (JP); Kiyoshi Nishimura, Yokosuka-shi (JP); Kozo Ogawa, Yokosuka-shi (JP)

(72) Inventors: Masao Segawa, Yokosuka-shi (JP); Nobuo Shibano, Yokosuka-shi (JP); Nobuhiko Betsuda, Yokosuka-shi (JP); Kiyoshi Nishimura, Yokosuka-shi (JP); Kozo Ogawa, Yokosuka-shi (JP)

(73) Assignees: KABUSHIKI KAISHA TOSHIBA, Minato-ku, Tokyo (JP); TOSHIBA LIGHTING & TECHNOLOGY CORPORATION, Yokosuka-shi, Kanagawa (JP)

(21) Appl. No.: 13/496,681

(22) PCT Filed: Jan. 12, 2011
(86) PCT No.: PCT/JP2011/050370

§ 371 Date: Mar. 16, 2012

(30) Foreign Application Priority Data
Jan. 14, 2010 (JP) 2010-006173

(51) Int. Cl. F21V 21/00; F21V 29/02

(52) U.S. Cl. CPC F21V 21/00; F21V 29/027
USPC 362/235; 362/249.02

(57) ABSTRACT

A bulb-type lamp includes a base body, a heat pipe, a light-emitting body, a cap and a lighting circuit. One end side of the heat pipe protrudes from one end side of the base body, and the other end side of the heat pipe is connected to the one end side of the base body. The light-emitting body includes plural LED elements, is connected to the one end side of the heat pipe, and is attached to the heat pipe to enable heat conduction. The cap is provided at the other end side of the base body. The lighting circuit is housed in the base body.

### TECHNICAL FIELD

Embodiments of the invention relate to a bulb-type lamp using a semiconductor light-emitting element and a luminaire using this bulb-type lamp.

### BACKGROUND ART

Hitherto, in a bulb-type lamp using an LED as a semiconductor light-emitting element, a light-emitting module including the LED is arranged on the other end side of a base body including a cap on one end side, and further, a globe covering the light-emitting module is arranged, and a lighting circuit to light the LED by supplying electric power is arranged in the base body.

In the light-emitting module, in general, plural LEDs are mounted on a flat board, and the board is attached to the base body in a surface contact state. At the time of lighting of the bulb-type lamp, since heat generated by the LEDs is efficiently conducted from the flat board to the base body, and is discharged to the air from the outer surface of the base body exposed to the outside, the temperature rise of the LEDs can be suppressed.

Besides, as the light-emitting module, there is one in which the shape of the board is made a polyhedral shape such as a triangular pyramid or a quadrilateral, and LEDs are mounted on the respective surfaces. In the bulb-type lamp using the polyhedral board, the base body is formed to be small, a cylindrical column protrudes from the other end side of the base body, the polyhedral board is attached to the tip of the column, and a lighting circuit is arranged in the column.

### Citation List

### Patent Literature

PTL1: Japanese Patent No. 4290887

### SUMMARY OF INVENTION

### Technical Problem

In the case of the bulb-type lamp using the light-emitting module in which the LEDs are mounted on the flat board, the heat generated by the LEDs at the time of lighting can be efficiently conducted from the flat board to the base body, and the temperature rise of the LEDs can be suppressed. However, since the light of the LEDs directed toward the one end side as the cap side is blocked by the board or the base body, a luminous intensity distribution in a range of only about 130° is obtained, a wide luminous intensity distribution characteristic close to that of an incandescent lamp is not obtained, and there is a problem that the bulb-type lamp is not suitable for a luminaire which is required to have the wide luminous intensity distribution characteristic.

Besides, in the case of the bulb-type lamp using the light-emitting module in which the LEDs are mounted on the polyhedral board, since the polyhedral board is arranged by the column in the vicinity of the center of the globe separate from the base body, the light of the LEDs directed toward the direction of the one end side as the cap side becomes hard to be blocked by the base body, and therefore, the wide luminous intensity distribution characteristic close to that of the incandescent lamp becomes easily obtained. However, since the polyhedral board is supported by the cylindrical column relatively to the base body, there is a problem that it becomes difficult to efficiently thermally conduct heat generated by the LEDs to the base body at the time of lighting, the temperature of the LEDs is liable to rise, and the life of the LEDs becomes short, or in order to suppress the temperature rise of the LEDs, the input power to the LEDs is reduced, and the light output must be suppressed.

A problem that the invention is to solve is to provide a bulb-type lamp in which a wide luminous intensity distribution characteristic is obtained and a thermal radiation property is also improved, and a luminaire using this bulb-type lamp.

### Solution to Problem

A bulb-type lamp according to an embodiment includes a base body, a heat pipe, a light-emitting body, a cap and a lighting circuit . One end side of the heat pipe protrudes from one end side of the base body, and the other end side of the heat pipe is arranged at the one end side of the base body to enable heat conduction. The light-emitting body includes plural semiconductor light-emitting elements, is connected to the one end side of the heat pipe, and is attached to the heat pipe. The cap is provided at the other end side of the base body. The lighting circuit is housed in the base body.

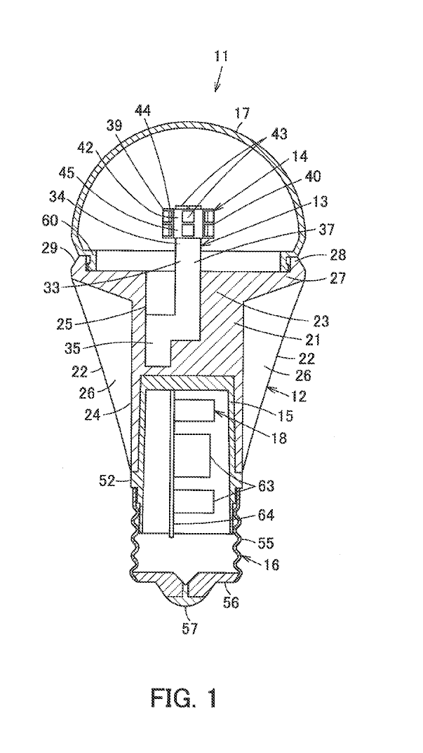

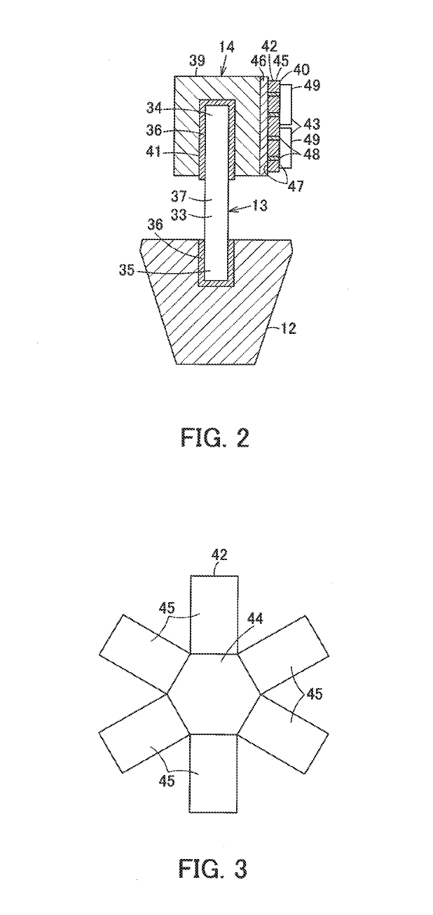

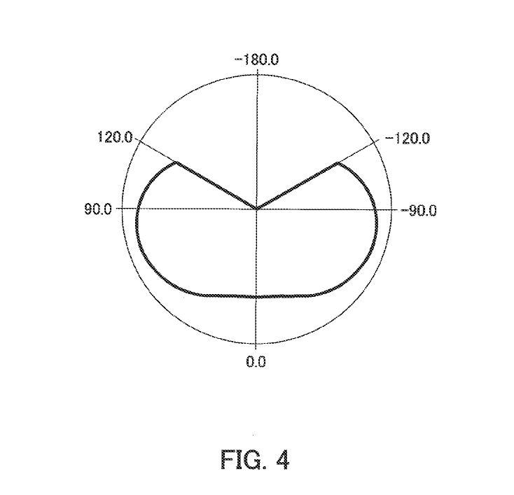

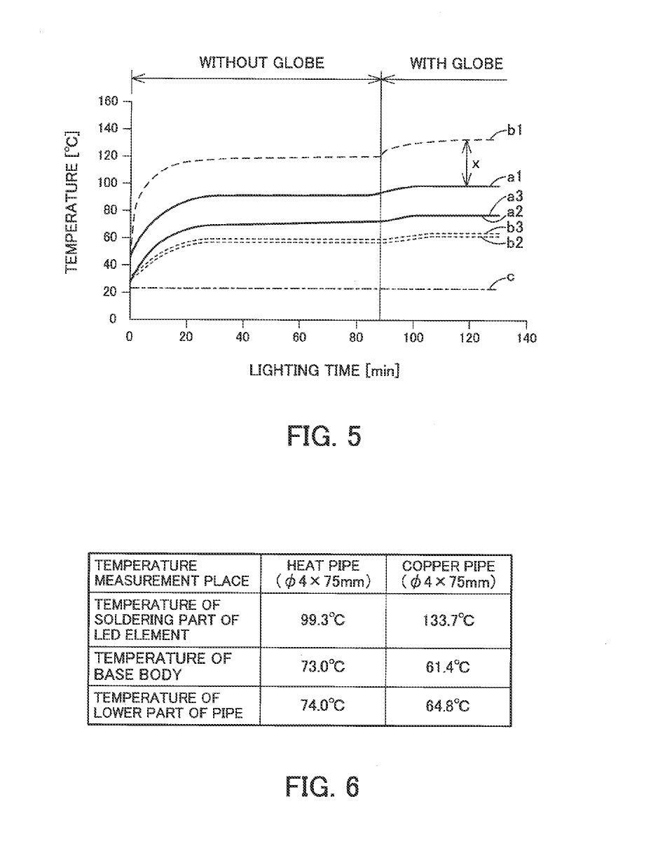

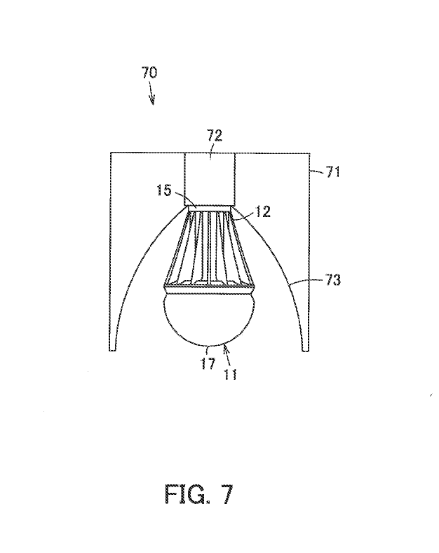

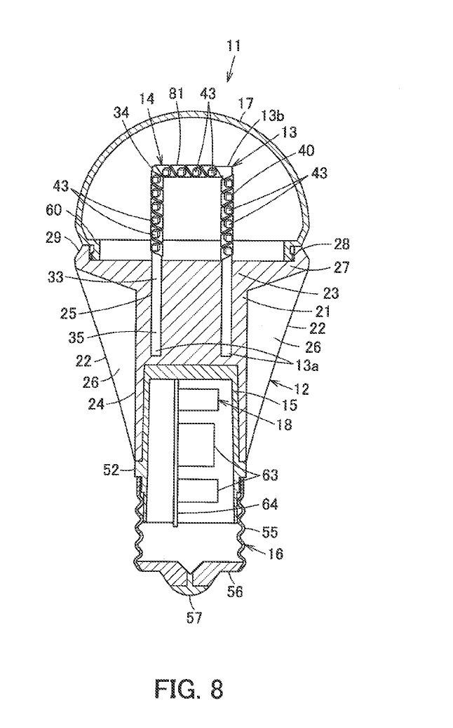

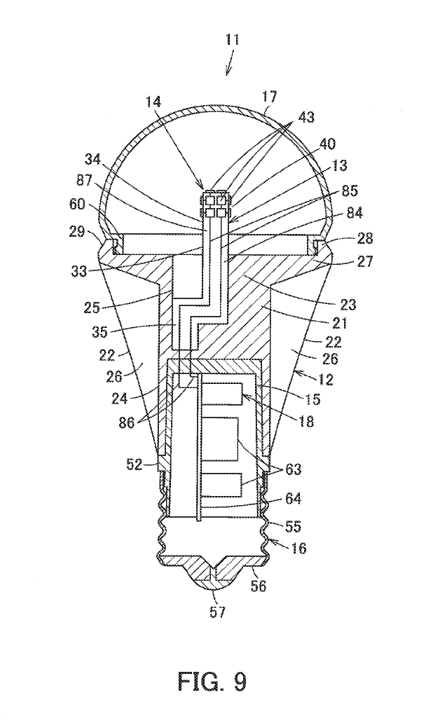

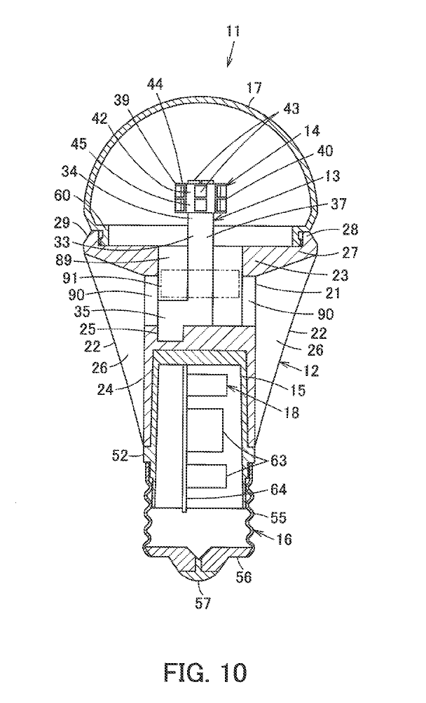

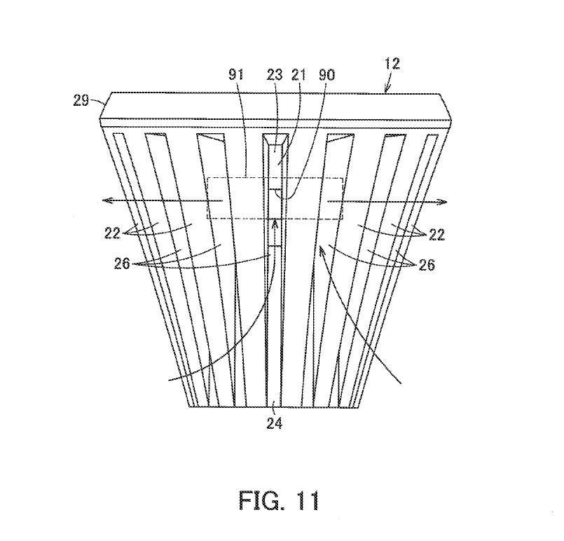

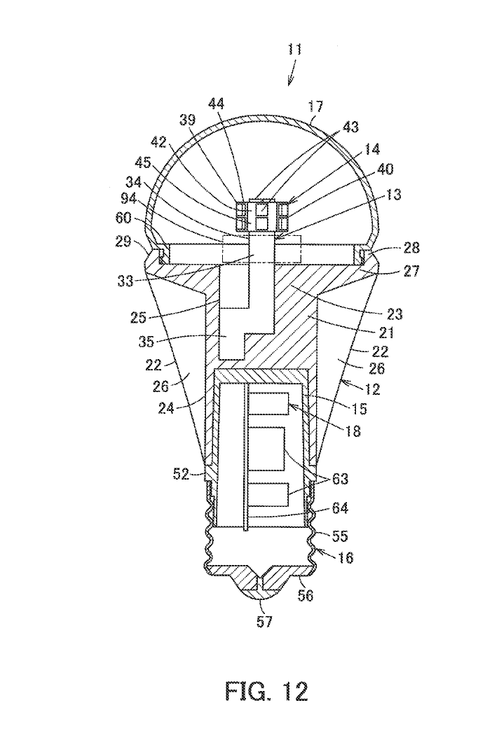

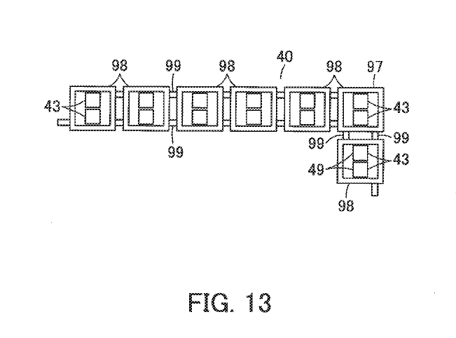

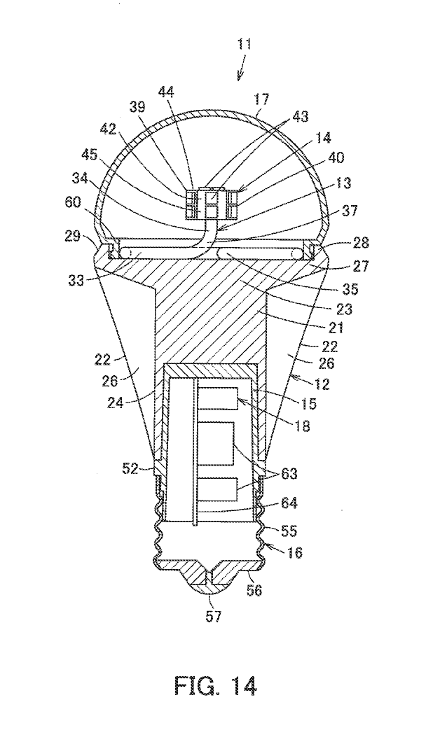

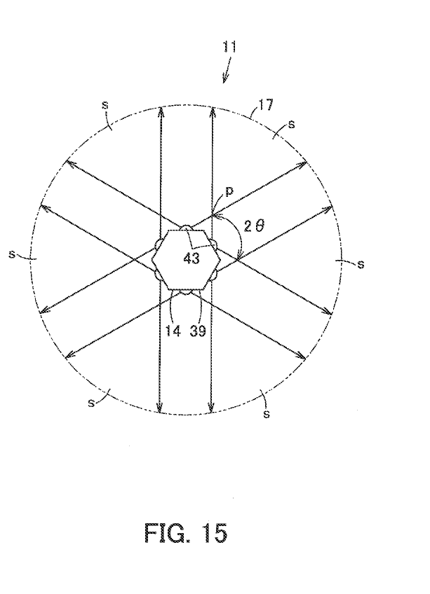

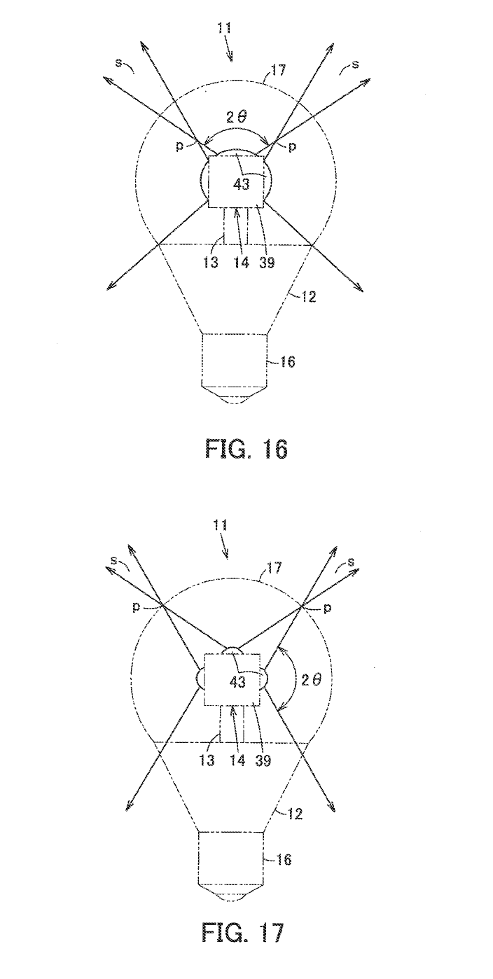

### BRIEF DESCRIPTION OF THE DRAWINGS

[FIG. 1] A sectional view of a bulb-type lamp showing a first embodiment.

[FIG. 2] A sectional view of a part of the bulb-type lamp.

[FIG. 3] A developed view of a board of a light-emitting body of the bulb-type lamp.

[FIG. 4] A luminous intensity distribution view of the bulb-type lamp.

[FIG. 5] A graph showing a relation between a lighting time and a temperature of the bulb-type lamp.

[FIG. 6] A table showing temperatures of the bulb-type lamp and a comparative example at the time of lighting.

[FIG. 7] A sectional view of a luminaire using the bulb-type lamp.

[FIG. 8] A sectional view of a bulb-type lamp showing a second embodiment.

[FIG. 9] A sectional view of a bulb-type lamp showing a third embodiment.

[FIG. 10] A sectional view of a bulb-type lamp showing a fourth embodiment.

[FIG. 11] A side view of a base body of the bulb-type lamp.

[FIG. 12] A sectional view of a bulb-type lamp showing a fifth embodiment.

[FIG. 13] A developed view of a board of a light-emitting body of a bulb-type lamp showing a sixth embodiment.

[FIG. 14] A sectional view of a bulb-type lamp showing a seventh embodiment.

[FIG. 15] An explanatory view of a luminous intensity distribution seen from one end side of a bulb-type lamp showing an eighth embodiment.

[FIG. 16] An explanatory view of the luminous intensity distribution seen from a side surface of the bulb-type lamp.

[FIG. 17] An explanatory view of a luminous intensity distribution seen from a side surface of a bulb-type lamp showing a ninth embodiment.

### DESCRIPTION OF EMBODIMENTS

Hereinafter, a first embodiment will be described with reference to FIG. 1 to FIG. 7.

In FIG. 1, 11 denotes a bulb-type lamp, and this bulb-type lamp 11 includes a base body 12, a heat pipe 13 protruding from one end side of the base body 12 (one end side of a lamp axis of the bulb-type lamp 11) , a light-emitting body 14 attached to a tip at one end side of the heat pipe 13, a cover 15 attached to the other end side of the base body 12 and having an insulation property, a cap 16 attached to the other end side of the cover 15, a globe 17 covering the heat pipe 13 and the light-emitting body 14, attached to the one end side of the base body 12 and having transparency, and a lighting circuit 18 housed between the base body 12 and the cap 16 and inside the cover 15.

The base body 12 is integrally formed of a metal material, such as ceramic or aluminum, having thermal conductivity. A base body part 21 as a barrel part is formed in a center area, and plural thermal radiation fins 22 along a lamp axis direction are formed around the base body part 21 to radially protrude from the lamp axis.

A cylindrical solid part 23 is formed at one end side of the base body part 21, and a cylindrical part 24 opening toward the other end side is formed at the other end side. An insertion hole 25 in which the heat pipe 13 is inserted is formed in the solid part 23. The insertion hole 25 is formed to extend between the center of the solid part 23 and a position deviated from the center, and is opened toward the one end side of the base body part 21, but is closed at the other end side. Incidentally, a not-shown wiring hole through which the surface of the base body 12 at the one end side communicates with the inner surface of the cylindrical part 24 as the other end side is formed in the base body part 21 at a position deviated from the center of the lamp axis.

The thermal radiation fins 22 are formed to be inclined so that the amount of protrusion in the radial direction gradually increases from the other end side of the base body 12 to the one end side. The thermal radiation fins 22 are radially formed at substantially equal intervals in the circumferential direction of the base body 12, and gaps 26 are formed between the thermal radiation fins 22. The gaps 26 are opened toward the other end side of the base body 12 and toward the periphery, and are closed at the one end side of the base body 12. An annular edge part 27 continuous with the solid part 23 is formed around the solid part 23 at the one end side of the thermal radiation fins 22 and the gaps 26. An annular globe attachment part 28 to which the globe 17 is attached is formed to protrude on the surface of the edge part 27 at the one end side as a peripheral area. An inclined part 29 having a small diameter at the globe 17 side as the one end side is formed on the outer periphery of the globe attachment part 28.

The heat pipe 13 has, for example, a diameter of 4 to 10 mm and a length of about 50 mm, and a working liquid is sealed under reduced pressure in a pipe-shaped airtight container 33 made of copper. The structure is such that a series of phase changes continuously occur, that is, the working liquid absorbs latent heat at a high temperature part of the airtight container 33 and evaporates, the vapor moves to a low temperature part of the airtight container 33 and releases the latent heat and condenses, and the condensed working liquid flows back to the high temperature part by a capillary phenomenon, and the heat is quickly moved from the high temperature part of the airtight container 33 to the low temperature part.

One end part 34 of the heat pipe 13 in the axial direction (longitudinal direction) protrudes vertically from the center part of one end surface of the base body 12, and the other end part 35 is inserted in the insertion hole 25 of the base body 12 and is fixed in an embedded arrangement state. As shown in FIG. 2, a silicone grease 36 or a low temperature solder as a heat coupling member is interposed between the other end part 35 of the heat pipe 13 and the insertion hole 25 of the base body 12, and the thermal conductivity from the heat pipe 13 to the base body 12 is improved. When the low temperature solder is used, a plating process such as Ni-Sn plating is applied to the heat pipe 13 and the base body 12, and a soldering property is secured. As shown in FIG. 1, the other end part 35 of the heat pipe 13 is bent to be substantially L-shaped and a contact area with the base body 12 is increased.

Incidentally, the heat pipe 13 may be fixed to the base body 12 by filling an adhesive in the insertion hole 25 of the base body 12, or may be fixed to the base body 12 by attaching a fixing member, which supports the heat pipe 13, to the one end surface of the base body 12.

A reflecting film 37 is formed on the surface of the heat pipe 13 exposed between the base body 12 and the light-emitting body 14 by, for example, white painting or silver plating.

Besides, as shown in FIG. 1 and FIG. 2, the light-emitting body 14 includes a polyhedral support body 39 attached to the tip of the one end part 34 of the heat pipe 13 and a light-emitting module 40 attached to the surface of the support body 39.

The support body 39 has a hexagonal column shape having a diameter of 15 mm and a height of about 10 mm and is made of metal, and is particularly made of copper in order to adjust thermal expansion coefficient to that of the heat pipe 13 so that heat stress to the heat pipe 13 is not generated, and in order to improve thermal conductivity from the support body 39 to the heat pipe 13. The light-emitting modules 40 are attached to six surfaces of peripheral surfaces of the support body 39 and one surface of one end surface thereof. An attachment hole 41 in which the tip of the one end part 34 of the heat pipe 13 is inserted and which is attached to the heat pipe 13 is formed in the other end of the support body 39. The silicone grease 36 or low temperature solder as the heat coupling member is interposed between the one end part 34 of the heat pipe 13 and the attachment hole 41 of the support body 39, and the thermal conductivity from the support body 39 to the heat pipe 13 is improved. When the low temperature solder is used, the plating process such as Ni—Sn plating is applied to the heat pipe 13 and the support body 39, and the soldering property is secured.

The light-emitting module 40 includes a board 42, and LED elements 43 as plural semiconductor light-emitting elements mounted on the surface of the board 42.

As shown in FIG. 3, the board 42 is a polyimide flexible board having a thickness of about 20 to 50 μm, or a glass epoxy board having a thickness of about 100 μm and a bending property, and includes a center board part 44 and six peripheral board parts 45 radially extending from the periphery of the center board part 44. As shown in FIG. 2 (FIG. 2 shows only a part of the peripheral board part 45), the center board part 44 is adhered and fixed to the upper surface of the support body 39 through a thermal radiation sheet 46 with adhesive and excellent in thermal conductivity, and each of the peripheral board parts 45 is adhered and fixed to the six surfaces of the peripheral surfaces of the support body 39 through the thermal radiation sheets 46 respectively. A portion between the center board part 44 and each of the peripheral board parts 45 can be bent since the thickness of the glass epoxy board is about 100 μm.

The heat radiation sheet 46 has, for example, a thickness of about 100 μm, has an adhesive layer of several tens pm on both surfaces, has a sufficient adhesive force by being pressed at room temperature, and has such heat resistance that the adhesive force is not reduced even under environment exceeding 100° C. Further, although the thermal conductivity of the heat radiation sheet 46 is about 1 to 2 W/mk, since the thickness is thin, sufficient thermal conductivity is obtained.

A pattern 47 of, for example, copper is formed on a mount surface of the board 42 on which the LED element 43 is mounted and on an opposite attachment surface to be attached to the support body 39, and the patterns 47 on both the surfaces are connected through a through hole 48. The pattern 47 is formed also on the attachment surface of the board 42, so that the thermal conductivity from the board 42 to the support body 39 is improved.

As the LED element 43, an SMD (Surface Mount Device) package 49 with a connection terminal on which an LED chip is mounted is used. In the SMD package 49, the LED chip to emit, for example, blue light is arranged in the package, and the LED chip is sealed with a sealing resin such as, for example, silicone resin mixed with yellow phosphor which is excited by part of the blue light from the LED chip and emits yellow light. Accordingly, the surface of the sealing resin becomes a light-emitting surface, and white light is emitted from the light-emitting surface. A not-shown terminal for soldering connection to the pattern 47 of the board 42 is arranged on the side surface of the SMD package 49.

The cover 15 is made of an insulation material such as, for example, PBT resin and is formed into a cylindrical shape opening toward the other end side. An annular flange part 52 interposed between the base body 12 and the cap 16 to insulate them from each other is formed on the outer circumferential part of the cover 15 at the other end side. A not-shown wiring hole coaxially communicating with the wiring hole of the base body 12 is formed in the surface of the cover 15 at the one end side.

Besides, the cap 16 is such as, for example, an E26 type cap connectable to a socket for general illumination bulb, and includes a shell 55 fitted to, caulked and fixed to the cover 15, an insulating part 56 provided at the other end side of the shell 55, and an eyelet 57 provided on the top of the insulating part 56.

Besides, the globe 17 is made of a synthetic resin having light diffusion property, glass or the like and is formed into a dome shape to cover the heat pipe 13 and the light-emitting body 14. The other end side of the globe 17 is opened, and a fitting part 60 fitted to the inner peripheral side of the globe attachment part 28 of the base body 12 and fixed by an adhesive or the like is formed at the opening edge part.

The lighting circuit 18 is, for example, a circuit to supply constant current to the respective LED elements 43 of the light-emitting body 14, and includes a circuit board 64 on which plural circuit elements 63 constituting the circuit are mounted. The circuit board 64 is housed in the cover 15 and is fixed. The input side of the lighting circuit 18 is electrically connected to the shell 55 and the eyelet 57 of the cap 16 by a not-shown lead wire. The output side of the lighting circuit 18 is connected to the pattern 47 of the board 42 of the light-emitting body 14 by a not-shown lead wire inserted in the wiring hole of the cover 15 and the wiring hole of the base body 12.

FIG. 7 shows a luminaire 70 as a downlight using the bulb-type lamp 11. The luminaire 70 includes a luminaire main body 71, and a socket 72 and a reflecting body 73 are disposed in the luminaire main body 71.

When the cap 16 of the bulb-type lamp 11 is mounted to the socket 72 of the luminaire 70 and power is applied, the lighting circuit 18 operates, electric power is supplied to the plural LED elements 43 of the light-emitting body 14, the plural LED elements 43 emit light, and the lights of the LED elements 43 are diffused and radiated through the globe 17.

The light-emitting body 14 has a structure where the plural LED elements 43 are arranged around the polyhedral support body 39, is arranged at the tip of the other end part of the heat pipe 13 protruding from the other end side of the base body 12, is separate from the base body 12, and is arranged at substantially the center of the globe 17. Thus, the lights of the LED elements 43 pass through the side part of the base body 12, and are radiated to the cap 16 side, and a wide luminous intensity distribution characteristic is obtained.

FIG. 4 shows a luminous intensity distribution view of the bulb-type lamp 11. A bulb-type lamp having a related art structure in which a flat board mounted with LED elements is attached to one end surface of a base body has a luminous intensity distribution characteristic within a range of about 180°. However, according to the bulb-type lamp 11 of this embodiment, a wide luminous intensity distribution characteristic within a range of about 240° is obtained, and the luminous intensity distribution characteristic close to that of the case where an incandescent lamp is used can be obtained.

Further, since the reflecting film 37 is formed on the surface of the heat pipe 13 exposed between the base body 12 and the light-emitting body 14, the lights of the LED elements 43 reflected on the one end surface of the base body 12 and the inner surface of the globe 17 are efficiently reflected by the reflecting film 37, and can be emitted from the globe 17, and the light extraction efficiency of the bulb-type lamp 11 can be improved.

Besides, heat generated at the time of lighting of the plural LED elements 43 of the light-emitting body 14 is conducted from the LED elements 43 to the board 42 and the support body 39, and is conducted from the support body 39 to the one end part 34 of the heat pipe 13. The heat conducted to and absorbed by the one end part 34 of the heat pipe 13 is quickly moved to the other end part 35 having low temperature by the operation of the heat pipe 13. The heat moved to the other end part 35 of the heat pipe 13 and radiated is conducted to the base body 12 from the heat pipe 13, and is efficiently radiated to the air from the base body part 21 exposed to the outside of the base body 12 and the surfaces of the plural thermal radiation fins 22.

A graph of FIG. 5 shows a relation between lighting time and temperature of the bulb-type lamp 11, and a table of FIG. 6 shows the temperatures of the bulb-type lamp 11 and those of a comparative example at the time of lighting.

As the comparative example, a case is shown in which a copper pipe is used instead of the heat pipe 13. In both the heat pipe 13 and the copper pipe, the diameter was made 4 mm and the length was made 75 mm.

Temperature measurement was made at places to obtain temperature (a1, b1) of a soldering portion where the LED element 43 was connected to the board 42, surface temperature (a2, b2) of the base body 12, lower part temperature (a3) of the heat pipe 13, and lower part temperature (b3) of the copper pipe. The respective temperatures of the heat pipe 13 are a1, a2 and a3, and the respective temperatures of the copper pipe are b1, b2 and b3. Besides, the ambient temperature c is constant.

The graph shows the temperature in the state where the globe 17 does not exist in the period from the start of lighting to 90 minutes, and shows the temperature in the state where the globe 17 is mounted in the period after 90 minutes. The table shows temperature values when the globe 17 exists.

When the heat pipe 13 is used, as compared with the case where the copper pipe is used, the temperature of the soldering portion where the LED element 43 was connected to the board 42 was lowered by about 34° C. (temperature difference x) , while the surface temperature of the base body 12 and the temperature of the lower part of the heat pipe 13 were raised. This is because the heat generated by the LED elements 43 is quickly and efficiently moved from the one end part 34 of the heat pipe 13 to the other end part 35 by the heat pipe 13.

Thus, while the temperature of the LED elements 43 is kept low, the heat can be efficiently radiated from the surface of the base body 12 to the air.

As stated above, according to the bulb-type lamp 11, the one end side of the heat pipe 13 is protruded from the one end side of the base body 12, the other end side of the heat pipe 13 is inserted and arranged at the one end side in the base body 12, and the light-emitting body 14 including the plural LED elements 43 is attached to the one end side of the heat pipe 13 protruding from the base body 12. Thus, the LED elements 43 can be three-dimensionally arranged, and the wide luminous intensity distribution characteristic is obtained, and further, the heat of the LED elements 43 can be efficiently conducted to the base body 12 by the heat pipe 13, and the thermal radiation property from the base body 12 can be improved. Accordingly, the temperature rise of the LED elements 43 can be suppressed, and the life of the LED elements 43 can be prolonged, or the increase of light output due to the increase of input power to the LED elements 43 can be achieved.

Besides, the lighting circuit 18 is arranged to be close to the one end side in the base body 12 including the cap 16, and the other end part 35 of the heat pipe 13 is inserted and arranged at the one end side in the base body 12. Thus, the lighting circuit 18 is separated from the light-emitting body 14 and the heat pipe 13 to suppress the temperature rise of the lighting circuit 18, and the reliability can be improved. Further, the contact area between the heat pipe 13 and the base body 12 is widened, and the thermal conductivity from the heat pipe 13 to the base body 12 can also be improved.

Besides, since the LED elements 43 are arranged on the respective surfaces of the polyhedral support body 39, and the support body 39 is attached to the tip of the heat pipe 13 at the one end side, the LED elements 43 are three-dimensionally arranged and the wide luminous intensity distribution characteristic can be obtained.

Next, FIG. 8 shows a second embodiment.

As compared with the bulb-type lamp 11 of the first embodiment, a heat pipe 13 is formed into substantially a C-shape or substantially a U-shape, both end parts 13a are inserted and supported in a pair of insertion holes 25 formed in a base body 12, and an intermediate part 13b is protruded from the base body 12.

A light-emitting body 14 includes a band-shaped flexible board 81 as a board, and SMD packages 49 as plural LED elements 43 are mounted on one surface of the flexible board 81 along a longitudinal direction. The flexible board 81 is wound around the circumferential surface of the intermediate part 13b of the heat pipe 13 protruding from the base body 12 and is attached.

In the bulb-type lamp 11 constructed as stated above, since the light-emitting body 14 is arranged on the intermediate part 13b of the heat pipe 13 protruding from the base body 12, a wide luminous intensity distribution characteristic is obtained. Further, since both the end parts 13a of the heat pipe 13 are connected to the base body 12, heat conducted from the LED elements 43 to the intermediate part 13b of the heat pipe 13 moves to both the end parts 13a of the heat pipe 13, and can be conducted from the two places of both the end parts 13a to the base body 12. Thus, the thermal conductive performance is high and the thermal radiation can be improved.

Next, FIG. 9 shows a third embodiment.

As compared with the bulb-type lamp 11 of the first embodiment, a heat pipe 13 of, for example, a quadrilateral pipe is used, an insulating layer 84 is formed on the surface of the heat pipe 13, and a wiring layer 85 for electrically connecting LED elements 43 of a light-emitting body 14 to a lighting circuit 18 is formed on the insulating layer 84. The insulating layer 84 is formed of, for example, epoxy resin by a method such as dipping, powder coating or electrostatic coating, and has a thickness of about 10 to 50 μm. The wiring layer 85 is constructed by forming, for example, a gold or copper wiring pattern on a nickel under plating by an electrolytic method or an electroless method. The wiring layer 85 formed on a tip surface and a tip circumferential surface of one end part 34 of the heat pipe 13 is formed into a wiring pattern for LED mounting of the light-emitting body 14, and the wiring pattern of a curved surface part between a surface and a surface can be formed by using a laser exposure technique or the like.

The wiring layer 85 of the heat pipe 13 and the lighting circuit 18 are connected through a lead wire 86.

The light-emitting body 14 is constructed such that LED chips of the plural LED elements 43 are connected by soldering, alloy eutectic or the like onto the wiring layer 85 on the tip surface and the tip circumferential surface of the one end part 34 of the heat pipe 13. At this time, heat is applied to the heat pipe 13 to use it as a heater for connection, so that the LED chips of the LED elements 43 can be connected onto the wiring layer 85 by the soldering, alloy eutectic or the like. That is, the LED elements 43 are mounted by a COB (Chip On Board) system in which plural LED chips are directly arranged and mounted on the heat pipe 13 constituting a board.

A phosphor film 87 is formed by, for example, a dipping method or a resin forming method so as to cover the LED chips of the LED elements 43 mounted on the tip surface and the tip circumferential surface of the one end part 34 of the heat pipe 13. The phosphor film 87 is formed of, for example, a translucent resin dispersed with a phosphor which is excited by part of blue light from the LED chips of the LED elements 43 and emits yellow light. The phosphor film 87 may be formed only at a place of the light-emitting body 14 of the one end part 34 of the heat pipe 13, or may be formed on the whole area of the heat pipe 13 protruding from the base body 12.

In the bulb-type lamp 11 constructed as stated above, since the wiring layer 85 to electrically connect the LED elements 43 of the light-emitting body 14 to the lighting circuit 18 is formed on the heat pipe 13, a lead wire for connecting those becomes unnecessary, a connecting work of the lead wire is eliminated, and a disadvantage that a shadow of the lead wire is reflected on a globe 17 can be prevented.

If the phosphor film 87 is formed also on the surface of the heat pipe 13 exposed between the base body 12 and the light-emitting body 14, the phosphor film 87 at that portion is also excited by the light of the LED elements 43 and can emit light, and the light extraction efficiency of the bulb-type lamp 11 can be improved.

Incidentally, if the phosphor film 87 is formed only on the place of the light-emitting body 14, the foregoing reflecting film 37 may be formed on the surface of the heat pipe 13 exposed between the base body 12 and the light-emitting body 14.

Next, FIG. 10 and FIG. 11 show a fourth embodiment.

As compared with the bulb-type lamp 11 of the first embodiment, a space part of a thermal radiation fan housing part 89 is formed at one end side of a base body part 21 of a base body 12, and vent holes 90 communicating with the thermal radiation fan housing part 89 are formed in gaps 26 of thermal radiation fins 22.

A not-shown motor and a thermal radiation fan 91 including a fan rotated and driven by this motor are arranged in the thermal radiation fan housing part 89 of the base body 12. The thermal radiation fan 91 is arranged around a heat pipe 13 as the center, and is electrically connected so that electric power is supplied to the motor from a cap 16 or a lighting circuit 18.

The outer air is sucked into the base body 12 through the vent holes 90 formed in the base body 12 by rotation of the thermal radiation fan 91, and the air is sent so that the hot air in the base body 12 is discharged to the outside from the vent holes 90.

In the bulb-type lamp 11 constructed as stated above, since the thermal radiation fan 91 is arranged in the base body 12, the thermal radiation property from the base body 12 can be improved, and the increase of light output due to the increase of input power to the LED elements 43 can be achieved.

The thermal radiation fan 91 has a cooling power of about several W to about 30 W, and is suitable for the bulb-type lamp 11 having a total light flux of several hundred lm to several tens of thousands lm.

Incidentally, the heat pipe 13 does not pass through the thermal radiation fan 91, but maybe bent toward the outer edge part of the base body 12 at an upper part of the base body 12 or may be arranged in an arc shape.

Besides, rotation control to change the rotation direction of the thermal radiation fan 91 at specified periods maybe performed in view of reduction of the number of rotations of the thermal radiation fan 91 due to dust generation and the life.

Next, FIG. 12 shows a fifth embodiment.

As compared with the bulb-type lamp 11 of the first embodiment, a not-shown motor and a circulation fan 94 including a fan rotated and driven by this motor are arranged between one end surface of a base body 12 and a light-emitting body 14 in a globe 17. The circulation fan 94 is arranged around a heat pipe 13 as the center, and is electrically connected so that electric power is supplied to the motor from a cap 16 or a lighting circuit 18.

In the bulb-type lamp 11 constructed as stated above, since the air around the light-emitting body 14 heated by the heat of LED elements 43 at the time of lighting is forcibly circulated in the globe 17 by the rotation of the circulation fan 94, as compared with natural convection in the globe 17, the heat from the light-emitting body 14 can be efficiently conducted to the globe 17, the thermal radiation property from the globe 17 can be improved, and the increase of light output due to the increase of input power to the LED elements 43 can be achieved.

Besides, since the circulation fan 94 is arranged in the sealed globe 17, and the air is only circulated in the globe 17, reduction of the life due to the influence of the dust generation can be suppressed.

Next, FIG. 13 shows a sixth embodiment.

A rigid flexible board 97 is used as a board of a light-emitting module 40 of a light-emitting body 14. The rigid flexible board 97 includes plural rigid boards 98 arranged on respective surfaces of a support body 39, and flexible boards 99 for sequentially connecting the rigid boards 98.

The rigid board 98 is formed of a material such as, for example, aluminum, copper or glass epoxy. A pattern on which an LED element 43 is mounted is formed on a mount surface, a pattern connected to the flexible board 99 is formed on a surface opposite to the mount surface, and the patterns on both the surfaces are connected through a through hole.

The rigid board 98 is formed of the material such as, for example, aluminum, copper or glass epoxy, the patterns are formed on both the surfaces, and the patterns on both the surfaces are connected through the through hole. An SMD package 49 of the LED element 43 is mounted on the pattern of the mount surface of the rigid board 98, and the pattern on the surface opposite to the mount surface is connected to the flexible board 99.

The flexible boards 99 are sequentially connected so that one rigid board 98 (lower right one in FIG. 13) is arranged at the tip surface of the support body 39, and the remaining rigid boards 98 (six ones laterally arranged on the upper side of FIG. 13) are arranged on the respective surfaces of the peripheral surfaces of the support body 39.

Also when the respective rigid boards 98 of the rigid flexible board 97 are arranged on the respective surfaces of the support body 39, bonding and fixing are performed by using the foregoing thermal radiation sheet 46.

Next, FIG. 14 shows a seventh embodiment.

Similarly to the bulb-type lamp 11 of the first embodiment, one end part 34 of a heat pipe 13 protrudes from one end side of a base body 12, and is attached to a light-emitting body 14. However, a portion between an intermediate part of the heat pipe 13 and the other end part 35 is bent and formed into an arc shape at a peripheral part of the base body 12 and a globe 17 and along a circumferential direction along a globe attachment part 28 of the base body 12 and an inner circumference of a fitting part 60 of the globe 17, and contacts one end surface of the base body 12 and the fitting part 60 of the globe 17. The heat pipe 13 is fixed to the one end surface of the base body 12 and the fitting part 60 of the globe 17 by a low temperature solder or an adhesive having thermal conductivity. When the low temperature solder is used, a soldering property is secured by applying a plating process, such as Ni-Sn plating, to the heat pipe 13, the base body 12 and the fitting part 60 of the globe 17.

As stated above, the portion between the intermediate part of the heat pipe 13 and the other end part 35 is connected to the base body 12 and the globe 17, so that the heat of the LED elements 43 can be efficiently conducted to the base body 12 and the globe 17 by the heat pipe 13, and thermal radiation property from the base body 12 and the globe 17 can be improved. Especially, since the portion between the intermediate part of the heat pipe 13 and the other end part 35 is bent and formed into the arc shape so as to contact along the peripheral part of the base body 12 and the globe 17, the contact area becomes large, and the thermal conductivity from the heat pipe 13 to the base body 12 and the globe 17 can be improved. Further, the heat pipe 13 is soldered to the base body 12 and the globe 17, so that the thermal conductivity from the heat pipe 13 to the base body 12 and the globe 17 can be improved.

Incidentally, a part of the other end part 35 of the heat pipe 13 may be inserted in the base body 12.

Next, FIG. 15 and FIG. 16 show an eighth embodiment.

In FIG. 15, if a support body 39 of a light-emitting body 14 has a hexagonal column shape as in the bulb-type lamp 11 of the first embodiment, LED elements 43 arranged on six surfaces of peripheral surfaces of the support body 39 are such that a half-value luminous intensity distribution angle 20 of light intensity distribution is 60° or more, and here, ones having 120° are used.

By this, an area s where luminous intensity distributions of the adjacent LED elements 43 overlap with each other is formed at the intermediate position between the adjacent LED elements 43. The light emission intensity of the area s is 30 to 70% of the average light emission intensity of a vertical surface of the LED element 43, preferably 40 to 60%, and more preferably substantially 50%.

Further, as shown in FIG. 16, the same is applied to an LED element 43 arranged on an upper surface of the support body 39. An area s where luminous intensity distributions of the adjacent LED elements 43 overlap with each other is formed at an intermediate position between the LED element 43 arranged on the upper surface of the support body 39 and each of the LED elements 43 arranged on the peripheral surface, and the light emission intensity of the area s is within the foregoing range.

As stated above, since the light emission intensity at the intermediate position between the adjacent LED elements 43 is secured, when the light-emitting body 14 is seen from a circumferential direction, the occurrence of a dark part dependent on the direction of seeing is suppressed, and uniform brightness is obtained in any direction.

Thus, the globe 17 is not requested to have such a high light diffusion property as to prevent the dark part from being seen, the light diffusion property is lowered, and the light transmission property can be raised. Thus, the light extraction efficiency from the globe 17 can be improved.

Besides, an intersection p of the luminous intensity distributions of the adjacent LED elements 43 is positioned inside the globe 17, and by this, while the light transmittance of the globe 17 is raised, uniform luminous intensity distribution can be obtained.

Next, FIG. 17 shows a ninth embodiment.

As compared with the bulb-type lamp 11 of the eighth embodiment, a support body 39 of a light-emitting body 14 has a quadrilateral column shape. LED elements 43 arranged on four surfaces of peripheral surfaces of the support body 39 and an upper surface are such that a half-value luminous intensity distribution angle 2θ of light intensity distribution is 90° or more, and here, ones having 120° are used.

By this, an area s where luminous intensity distributions of the adjacent LED elements 43 overlap with each other is formed at the intermediate position between the adjacent LED elements 43. The light emission intensity of the area s is 30 to 70% of the average light emission intensity of a vertical surface of the LED element 43, preferably 40 to 60%, and more preferably substantially 50%.

As stated above, since the light emission intensity at the intermediate position between the adjacent LED elements 43 is secured, when the light-emitting body 14 is seen from a circumferential direction, the occurrence of a dark part dependent on the direction of seeing is suppressed, and uniform brightness is obtained in any direction.

Thus, the globe 17 is not requested to have such a high light diffusion property as to prevent the dark part from being seen, the light diffusion property is lowered, and the light transmission property can be raised. Thus, the light extraction efficiency from the globe 17 can be improved.

Besides, an intersection p of the luminous intensity distributions of the adjacent LED elements 43 is positioned at the globe 17, and by this, the lights incident on the globe 17 from the adjacent LED elements 43 intersect with each other and are averaged. Thus, not only the luminous intensity distribution is averaged by the globe 17, but also the light transmittance can be raised.

According to the bulb-type lamp 11 constructed as in the respective embodiments, the one end side of the heat pipe 13 is protruded from the one end side of the base body 12, the other end side of the heat pipe 13 is arranged at the one end side of the base body 12, and the light-emitting body 14 including the plural LED elements 43 is attached to the one end side of the heat pipe 13 protruding from the base body 12. Thus, the three-dimensional arrangement of the LED elements becomes possible, and the wide luminous intensity distribution characteristic is obtained. Further, the heat of the LED elements 43 can be efficiently conducted to the base body 12 by the heat pipe 13, and the thermal radiation property from the base body 12 can be improved. Further, the lighting circuit 18 is housed on the other end side in the base body 12, and can be arranged to be separated from the heat pipe 13. Thus, the temperature rise of the lighting circuit 18 is suppressed, and the reliability can be improved. Accordingly, the temperature rise of the LED elements 43 can be suppressed, and the life of the LED elements 43 can be prolonged, or the increase of the light output due to the increase of the input power to the LED elements 43 can be achieved.

Incidentally, in the respective embodiments, when the support body 39 is used for the light-emitting body 14, the LED elements 43 may be mounted by the COB (Chip On Board) system in which the plural LED chips are directly mounted on the respective surfaces of the support body 39 as the board, and the LED chips are sealed with sealing resin in which phosphor is mixed.

In this case, although the surface of the sealing resin becomes the light-emitting surface, if the area of the light-emitting surface occupies 50% or more of the area of the mount surface of the support body 39, the light emission intensity at the intermediate position between the LED elements 43 mounted on the adjacent surfaces of the support body 39 can be made to fall within the foregoing range. Accordingly, when the light-emitting body 14 is seen from the circumferential direction, the occurrence of a dark part dependent on the direction of seeing is suppressed, and uniform brightness is obtained in any direction.

Besides, the shape of the heat pipe 13 is not particularly limited as long as the shape has a portion protruding from the base body 12 and a portion inserted in or in contact with the base body 12. For example, the shape of the other end side of the heat pipe may be bent so that the contact area to the base body becomes wide.

Besides, as the semiconductor light-emitting element, an EL element may be used in addition to the LED element 49.

Besides, the cap 16 may be an E17 type cap connectable to a socket for general illumination bulb in addition to the E26 type.

Besides, the shape of the support body 39 may be any of a hexagonal column shape, a quadrilateral shape, a triangular shape and other polyhedral shapes.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

### REFERENCE SIGNS LIST

11 bulb-type lamp

12 base body

13 heat pipe

14 light-emitting body

16 cap

17 globe

18 lighting circuit

37 reflecting film

39 support body

43 LED element as a semiconductor light-emitting element

70 luminaire

71 luminaire main body

85 wiring layer

87 phosphor film

91 thermal radiation fan

94 circulation fan

1. A bulb-type lamp comprising:
a base body;
a heat pipe that includes one end side protruding from one end side of the base body, and the other end side connected to the one end side of the base body;
a light-emitting body that includes a plurality of semiconductor light-emitting elements, is connected to the one end side of the heat pipe, and is attached to the heat pipe to enable heat conduction;
a cap provided at the other end side of the base body; and
a lighting circuit housed in the base body.

2. The bulb-type lamp according to claim 1 comprising a globe attached to the one end side of the base body, wherein at least a portion between an intermediate part and the other end side of the heat pipe is connected to the base body to enable heat conduction.

3. The bulb-type lamp according to claim 1, wherein the light-emitting body includes a polygonal support body attached to a tip on the one end side of the heat pipe, and the semiconductor light-emitting elements are arranged on respective surfaces of the support body.

4. The bulb-type lamp according to claim 1, wherein a wiring layer to electrically connect the semiconductor light-emitting elements of the light-emitting body and the lighting circuit to the heat pipe is formed.

5. The bulb-type lamp according to claim 1, wherein one of a reflecting film and a phosphor film is formed on a surface of the heat pipe.

6. The bulb-type lamp according to claim 1, wherein the base body is provided with a thermal radiation fan.

7. The bulb-type lamp according to claim 1 comprising:
a globe that covers the heat pipe and the light-emitting body and is attached to the other end side of base body; and
a circulation fan arranged in the globe.

8. A bulb-type lamp comprising:
a base body;
a heat pipe that includes an intermediate part protruding from one end side of the base body, and both end sides connected to the one end side of the base body;
a light-emitting body that includes a plurality of semiconductor light-emitting elements, is connected to the intermediate part of the heat pipe, and is attached to the heat pipe to enable heat conduction;
a cap provided at the other end side of the base body; and
a lighting circuit housed in the base body.

9. A luminaire comprising:
a luminaire main body; and
a bulb-type lamp according to claim 1 arranged the luminaire main body.
